(19) United States
(12) Patent Application Publication
(10) Pub. No.: US 2026/0158419 A1
(43) Pub. Date: Jun. 11, 2026

(54) GAS-LIQUID SEPARATION STRUCTURE

(71) Applicant: Hino Motors, Ltd., Tokyo (JP)

(72) Inventors: Takahiro KAWAI, Tokyo (JP); Takeshi KASAKAWA, Tokyo (JP); Tsukasa MASHIMA, Tokyo (JP); Souta SASAKI, Tokyo (JP); Yoshimasa SATO, Tokyo (JP)

(73) Assignee: Hino Motors, Ltd., Tokyo (JP)

(21) Appl. No.: 19/405,978

(22) Filed: Dec. 2, 2025

(30) Foreign Application Priority Data
Dec. 5, 2024 (JP) 2024-212482

(51) Int. Cl. B01D 19/00; H01M 10/625; H01M 10/6567

(52) U.S. Cl. CPC B01D 19/0042; H01M 10/625; H01M 10/6567; H01M 2220/20

(57) ABSTRACT

A gas-liquid separation structure that is mounted on a vehicle and is for separating gas from a coolant while circulating the coolant for cooling a target element of the vehicle, the structure including a branch joint for receiving inflow of the coolant returning from the target element and discharging the inflowed coolant in a branched manner to the target element and other element, in which the branch joint includes a body having an internal space elongated in a vertical direction, and a first inflow part penetratingly provided in the body so as to have a first opening that opens into the internal space, the first inflow part allowing the coolant returning from the target element to flow into the internal space from the first opening.

### TECHNICAL FIELD

The present disclosure relates to a gas-liquid separation structure.

### BACKGROUND

Japanese Unexamined Patent Publication No. H8-210135 discloses a structure provided with a surge tank having a gas-water separation function. In this structure, cooling water discharged from a water pump flows to a radiator and is returned from a lower tank of the radiator to the water pump. Further, the cooling water is sent from an upper tank of the radiator to the surge tank, and the cooling water from which air has been separated in the surge tank is returned to the water pump via an outlet pipe.

### SUMMARY

Incidentally, when the gas-liquid separation structure in the above technical field is mounted on a vehicle, efficiency is required in terms of mass, cost, and space. On the other hand, in the structure described in Japanese Unexamined Patent Publication No. H8-210135, a separate member such as a surge tank is required to separate air from the cooling water. Therefore, it is inefficient in terms of mass, cost, and space.

Therefore, the present disclosure aims to provide a more efficient gas-liquid separation structure.

A gas-liquid separation structure according to the present disclosure is [1] “a gas-liquid separation structure that is mounted on a vehicle and is configured to separate gas from a coolant while circulating the coolant for cooling a target element of the vehicle, the structure including a branch joint configured to receive inflow of the coolant returning from the target element and to discharge the inflowed coolant in a branched manner to the target element and other element, in which the branch joint includes a body having an internal space elongated in a vertical direction, a first inflow part penetratingly provided in the body so as to have a first opening that opens into the internal space, the first inflow part allowing the coolant returning from the target element to flow into the internal space from the first opening, a first discharge part penetratingly provided in the body so as to have a second opening that opens into the internal space below a first position that is below the first opening, the first discharge part discharging the coolant, which has flowed in from the first opening and has flowed through the internal space downward, from the second opening toward the target element, and a second discharge part penetratingly provided in the body so as to have a third opening that opens into the internal space above the first opening, the second discharge part discharging the coolant, which has been introduced from the first opening and has flowed through the internal space upward, from the third opening toward the other element”.

In this gas-liquid separation structure, the branch joint for branching the coolant returning from the target element of the vehicle includes a body including an internal space elongated in the vertical direction, a first inflow part penetratingly provided in the body so as to have a first opening that opens into the internal space, the first inflow part allowing the coolant returning from the target element to flow into the internal space from the first opening, a first discharge part penetratingly provided in the body so as to have a second opening that opens into the internal space below the first opening, the first discharge part discharging the coolant, which has flowed in from the first opening and has flowed through the internal space downward, from the second opening toward the target element, and a second discharge part penetratingly provided in the body so as to have a third opening that opens into the internal space above the first opening, the second discharge part discharging the coolant, which has flowed in from the first opening and has flowed through the internal space upward, from the third opening toward the other element. Therefore, among the coolant caused to flow into the internal space from the first opening by the first inflow part, a part of the coolant that relatively contains a large amount of gas flows through the internal space upward and is discharged from the second discharge part via the third opening, and the remainder of the coolant that does not contain much gas (or does not contain gas) flows through the internal space downward and is discharged from the first discharge part via the second opening. Accordingly, by repeating the circulation of the coolant using this branch joint, gas from the coolant can be separated suitably. Thus, in this gas-liquid separation structure, gas can be separated from the coolant in the branch joint for branching the coolant (that is, without using a separate member such as a surge tank), and it is more efficient in terms of mass, cost, and space.

As related art gas-liquid separation structures, those that require driving a pump are known, but in this case, the effort and power to drive the pump are required, which is inefficient. Further, as related art gas-liquid separation structures, those using the principle of centrifugal separation are known, but in this case, a space for centrifugally separating the coolant is required, and the component becomes large, which is inefficient in terms of mass and cost. Furthermore, as a related art gas-liquid separation method, a method is known in which an air bleeding component is set and the air bleeding component is opened and closed each time. In this case, a separate component is set only for discharging air, which is inefficient in terms of mass, cost, and space. Further, in this case, it is inefficient because pre-treatment is required to prevent the coolant discharged together with the air from the air discharge port of the air bleeding component from flowing into the sewage, and consideration is required to prevent the coolant from scattering to peripheral devices or the human body. According to the gas-liquid separation structure according to the present disclosure, compared to these related art gas-liquid separation structures and methods, it is more efficient, and consideration for treatment and scattering of the coolant is also unnecessary.

The gas-liquid separation structure according to the present disclosure may be [2] “the gas-liquid separation structure according to [1], in which the body includes a constriction part that narrows the internal space at the first position so as to make an inner diameter of the internal space narrower than a diameter of the first opening”. In this case, among the coolant that has flowed into the internal space of the body via the first opening, a part of the coolant that relatively contains a large amount of gas can be made difficult to flow downward (toward the second opening) by the constriction part, thereby making it possible to more effectively flow upward (toward the third opening) and be discharged from the second discharge part.

The gas-liquid separation structure according to the present disclosure may be [3] “the gas-liquid separation structure according to [2], in which a diameter of the constriction part is not less than ⅓ and not more than ½ of a diameter of the first opening of the first inflow part”. In this case, among the coolant that has flowed into the internal space of the body from the first inflow part via the first opening, a part of the coolant that relatively contains a large amount of gas can be more effectively caused to flow upward (toward the third opening) and be discharged from the second discharge part.

The gas-liquid separation structure according to the present disclosure may be [4] “the gas-liquid separation structure according to any one of [1] to [3], further including a supply pipe as the other element configured to supply the coolant to the internal space, in which the branch joint includes a second inflow part penetratingly provided in the body so as to have a fourth opening that opens into the internal space below the first position, the second inflow part allowing the coolant to flow into the internal space from the fourth opening, and in which the supply pipe includes a first connection part connected to the second discharge part and a second connection part connected to the second inflow part below the first connection part, the supply pipe supplying the coolant to the internal space by causing the coolant discharged from the second discharge part and introduced from the first connection part to flow downward and leading the coolant out from the second connection part toward the second inflow part”. In this case, by causing the coolant discharged from the second discharge part and introduced from the first connection part to flow downward in the supply pipe and leading the coolant out from the second connection part toward the second inflow part, gas-liquid separation of the coolant can be reliably performed in the supply pipe.

The gas-liquid separation structure according to the present disclosure may be [5] “the gas-liquid separation structure according to [4], in which an inner diameter of the supply pipe is larger than a diameter of the third opening of the second discharge part”. In this case, when the coolant is introduced from the second discharge part into the supply pipe, the flow velocity of the coolant becomes slower, thereby making it possible to more reliably perform gas-liquid separation of the coolant in the supply pipe.

The gas-liquid separation structure according to the present disclosure may be [6] “the gas-liquid separation structure according to [4] or [5], further including an auxiliary tank configured to store the coolant, and a connection pipe configured to connect the supply pipe and the auxiliary tank, in which the connection pipe is connected to the supply pipe at an upper end portion of the supply pipe and is configured to discharge the gas separated from the coolant and stored in the upper end portion of the supply pipe to the auxiliary tank”. In this case, the gas separated from the coolant in the supply pipe can be discharged via the auxiliary tank.

The gas-liquid separation structure according to the present disclosure may be [7] “the gas-liquid separation structure according to [6], in which the connection pipe is configured to supply the coolant stored in the auxiliary tank to the supply pipe in response to a change in internal pressure of the supply pipe, by having an end portion on a side opposite to an end portion connected to the supply pipe immersed in the coolant stored in the auxiliary tank”. In this case, since the coolant stored in the auxiliary tank is supplied to the supply pipe in response to a change in internal pressure of the supply pipe, the liquid amount of the coolant is suitably maintained.

According to the present disclosure, a more efficient gas-liquid separation structure can be provided.

### BRIEF DESCRIPTION OF THE DRAWINGS

FIG. 1 is a schematic diagram illustrating a gas-liquid separation structure according to the present embodiment.

FIG. 2 is an enlarged schematic cross-sectional view illustrating the branch joint illustrated in FIG. 1.

### DETAILED DESCRIPTION

Hereinafter, an embodiment will be described with reference to the drawings. In the description of the drawings, the same or corresponding elements are denoted by the same reference numerals, and overlapping descriptions may be omitted.

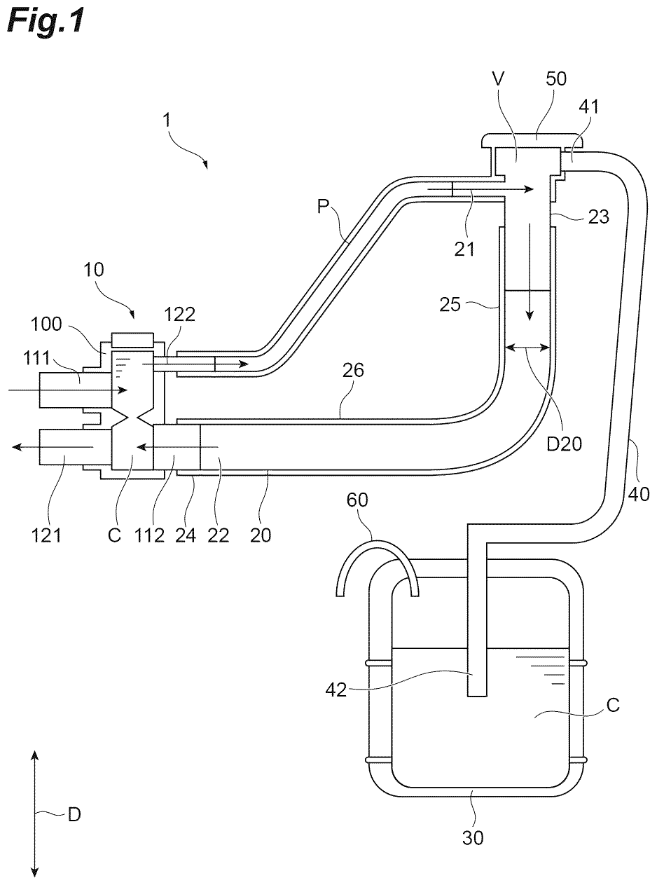

FIG. 1 is a schematic diagram illustrating a gas-liquid separation structure according to the present embodiment. A gas-liquid separation structure 1 illustrated in FIG. 1 is mounted on a vehicle such as an electric vehicle. The gas-liquid separation structure 1 is configured to separate gas V from a coolant C while circulating the coolant C for cooling a target element (for example, an electric motor, a battery, or the like) in the vehicle.

The gas-liquid separation structure 1 includes a branch joint 10, a supply pipe 20, an auxiliary tank 30, and a connection pipe 40. The branch joint 10 is for receiving inflow of the coolant C returning from the target element and discharging the inflowed coolant C in a branched manner to the target element and other element. More specifically, the branch joint 10 branches the coolant C so as to return a part of the coolant C returning from the target element to the target element and to direct the remainder of the coolant C returning from the target element toward the supply pipe 20 as the other element.

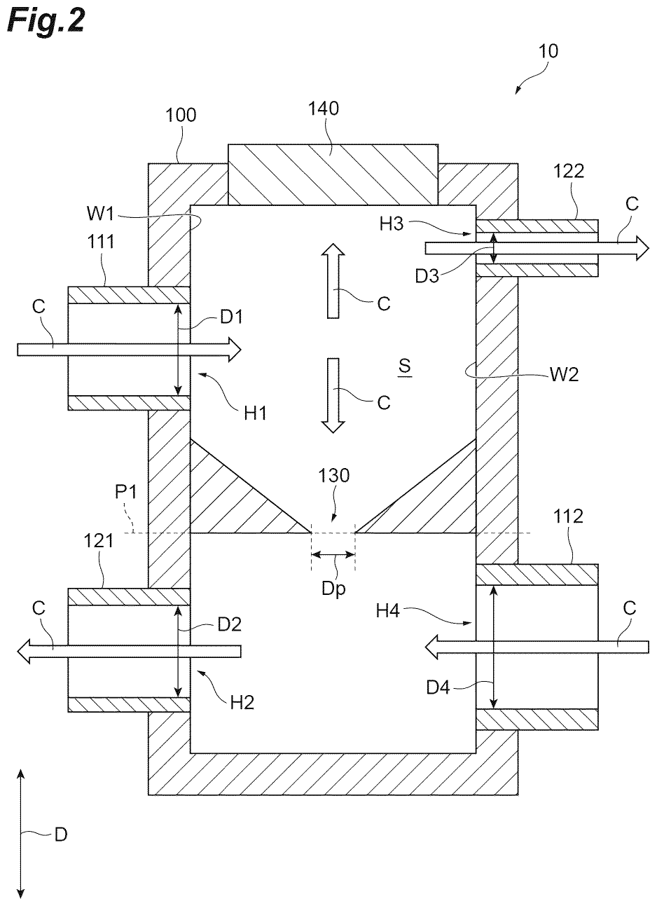

FIG. 2 is a schematic cross-sectional view illustrating the branch joint illustrated in FIG. 1 in an enlarged manner. As illustrated in FIGS. 1 and 2, the branch joint 10 has a body 100, a first inflow part 111, a second inflow part 112, a first discharge part 121, and a second discharge part 122. Further, the body 100 includes an internal space S elongated in a vertical direction D. Here, as an example, the body 100 is formed in a rectangular parallelepiped shape elongated in the vertical direction D, and the internal space S is defined by a plurality of inner wall surfaces of the body 100 to have a substantially rectangular parallelepiped shape elongated in the vertical direction D.

The first inflow part 111, the second inflow part 112, the first discharge part 121, and the second discharge part 122 each have a cylindrical shape and are penetratingly provided in the body 100 so as to communicate with the internal space S. More specifically, the first inflow part 111 is penetratingly provided in the body 100 so as to have a first opening H1 that opens into the internal space S, for example, above a center of the body 100 in the vertical direction D. The first inflow part 111 allows the coolant C returning from the target element to flow into the internal space S from the first opening H1.

Note that the first opening H1 opening into the internal space S above the center of the body 100 in the vertical direction D means, for example, that at least a center of the first opening H1 in the vertical direction D is above a center of the body 100 in the vertical direction D.

The first discharge part 121 is penetratingly provided in the body 100 so as to have a second opening H2 that opens into the internal space S below a first position P1 that is below the first opening H1. The first position P1 is an arbitrary position between the first opening H1 and the second opening H2 in the vertical direction D, and is, as an example, a position where a constriction part 130 described later is provided. The first discharge part 121 discharges the coolant C, which has flowed in from the first opening H1 and has flowed through the internal space S downward, from the second opening H2 toward the target element. In the present embodiment, as an example, the first opening H1 of the first inflow part 111 and the second opening H2 of the first discharge part 121 are arranged in the vertical direction on the same inner wall surface W1 among a plurality of inner wall surfaces of the body 100.

Note that the first discharge part 121 discharging the coolant C toward the target element is not limited to a case where the coolant C discharged from the first discharge part 121 directly reaches the target element, but includes, for example, a case where it reaches the target element via another element such as a pump. In the present embodiment, as an example, the coolant C discharged from the first discharge part 121 may be configured to be directed toward a battery as the target element via a pump.

The second discharge part 122 is penetratingly provided in the body 100 so as to have a third opening H3 that opens into the internal space S above the first opening H1. The second discharge part 122 discharges the coolant C, which has been introduced from the first opening H1 and has flowed through the internal space S upward, from the third opening H3 toward the supply pipe 20. In the present embodiment, as an example, the third opening H3 of the second discharge part 122 is formed on an inner wall surface W2 that faces the inner wall surface W1 on which the first opening H1 of the first inflow part 111 and the second opening H2 of the first discharge part 121 are formed, among the plurality of inner wall surfaces of the body 100.

Note that the third opening H3 being above the first opening H1 means that at least a center of the third opening H3 in the vertical direction D is above a center of the first opening H1 in the vertical direction D. In the present embodiment, as an example, a lower end of the third opening H3 is positioned above an upper end of the first opening H1.

The second inflow part 112 is penetratingly provided in the body 100 so as to have a fourth opening H4 that opens into the internal space S below the first position P1. The second inflow part 112 allows the coolant C from the supply pipe 20 to flow into the internal space S from the fourth opening H4. The fourth opening H4 of the second inflow part 112 is positioned below the third opening H3 of the second discharge part 122. In the present embodiment, as an example, the third opening H3 of the second discharge part 122 and the fourth opening H4 of the second inflow part 112 are arranged in the vertical direction on the same inner wall surface W2 among the plurality of inner wall surfaces of the body 100.

Here, the body 100 further includes a constriction part 130 that narrows the internal space S at a position between the first opening H1 and the second opening H2 in the vertical direction D (here, the first position P1) so as to make an inner diameter of the internal space S narrower than a diameter D1 of the first opening H1. The constriction part 130 is provided over the entire circumference of the inner wall surface of the body 100 so as to be annular (for example, the inner edge is annular) when viewed from above. Note that the constriction part 130 being provided at the first position P1 means, as an example, that an upper end portion of the narrowest portion of the constriction part 130 is positioned at the first position P1.

A diameter Dp of the constriction part 130 is, for example, not less than ⅓ and not more than ½ of the diameter D1 of the first opening H1 of the first inflow part 111. As an example, the diameter of the first opening H1 is about 25 mm, and the diameter Dp of the constriction part 130 is about 10 mm. Further, a diameter D3 of the third opening H3 of the second discharge part 122 is, for example, about the same as the diameter Dp of the constriction part 130, and is about 10 mm as an example.

Further, a diameter D4 of the fourth opening H4 of the second inflow part 112 is, for example, larger than the diameter D3 of the third opening H3 (here, larger than the diameter D1 of the first opening H1), and is about 30 mm as an example. Furthermore, a diameter D2 of the second opening H2 of the first discharge part 121 is, for example, about the same as the diameter D1 of the first opening H1, and is about 25 mm as an example.

The supply pipe 20 supplies the coolant C to the internal space S of the branch joint 10. More specifically, the supply pipe 20 includes a first connection part 21 connected to the second discharge part 122, and a second connection part 22 connected to the second inflow part 112 below the first connection part 21. The first connection part 21 is connected to the second discharge part 122 via a pipe P having an inner diameter about the same as the diameter D3 of the third opening H3 of the second discharge part 122 (that is, about 10 mm).

The supply pipe 20 is formed in an L-shape by a first portion 25 that includes one end portion 23 where the first connection part 21 is provided and extends along the vertical direction D, and a second portion 26 that includes the other end portion 24 where the second connection part 22 is provided and extends in a horizontal direction from a lower end of the first portion 25. Thereby, the supply pipe 20 supplies the coolant C to the internal space S by causing the coolant C discharged from the second discharge part 122 and introduced from the first connection part 21 to flow downward and leading it out from the second connection part 22 toward the second inflow part 112.

An inner diameter D20 of the supply pipe 20 is made larger than the diameter D3 of the third opening H3 of the second discharge part 122 (that is, the inner diameter of the pipe P). Thereby, the flow velocity of the coolant C discharged from the second discharge part 122 is reduced when flowing through the supply pipe 20. The inner diameter D20 of the supply pipe 20 is, for example, not less than twice and not more than four times the diameter D3 of the third opening H3, and is about 30 mm as an example. The supply pipe 20 may be formed of, for example, a rubber hose.

In the gas-liquid separation structure 1, among the coolant C that has returned from the target element and has flowed into the internal space S of the branch joint 10 from the first inflow part 111, a part of the coolant C that relatively contains a large amount of gas flows through the internal space S upward and is discharged from the second discharge part 122. The coolant C discharged from the second discharge part 122 is introduced into one end portion 23, which is an upper end portion of the supply pipe 20, via the pipe P and the first connection part 21. The coolant C introduced into the one end portion 23 of the supply pipe 20 flows through the supply pipe 20 downward and is then returned to the internal space S of the branch joint 10 via the second connection part 22 and the second inflow part 112.

The coolant C returned to the internal space S via the second inflow part 112 merges with part of the coolant C that has flowed downward without containing much gas among the coolant C that has flowed into the internal space S from the first inflow part 111, and is discharged from the first discharge part 121 toward the target element. In the gas-liquid separation structure 1, the gas V is separated from the coolant C by continuous repetition of the circulation of the coolant C as described above. The gas V separated from the coolant C is stored in the one end portion 23, which is the upper end portion of the supply pipe 20, and may form a gas pocket.

Here, the auxiliary tank 30 stores the coolant C. The connection pipe 40 connects the supply pipe 20 and the auxiliary tank 30. One end portion 41 of the connection pipe 40 is connected to the one end portion 23, which is the upper end portion of the supply pipe 20, and the other end portion 42 on the side opposite to the one end portion 41 of the connection pipe 40 is immersed in the coolant C stored in the auxiliary tank 30. Thereby, the connection pipe 40 discharges the gas V (of the gas pocket) stored in the one end portion 23 of the supply pipe 20 to the auxiliary tank 30 in response to a change in internal pressure of the supply pipe 20 (for example, an increase in internal pressure) due to the circulation operation and stop of the coolant C.

Additionally, the connection pipe 40 supplies the coolant C stored in the auxiliary tank 30 to the supply pipe 20 in response to a change in internal pressure of the supply pipe 20 (for example, a decrease in internal pressure) due to the circulation operation and stop of the coolant C. Note that the gas V discharged to the auxiliary tank 30 may be released to the outside via, for example, an exhaust part 60 provided at an upper part of the auxiliary tank 30. The connection pipe 40 may be formed of, for example, a rubber hose.

As described above, in the gas-liquid separation structure 1 according to the present embodiment, the branch joint 10 for branching the coolant C returning from the target element of the vehicle includes the body 100 including the internal space S elongated in the vertical direction, the first inflow part 111 penetratingly provided in the body 100 so as to have the first opening H1 that opens into the internal space S, the first inflow part 111 allowing the coolant C returning from the target element to flow into the internal space S from the first opening H1, the first discharge part 121 penetratingly provided in the body 100 so as to have the second opening H2 that opens into the internal space S below the first opening H1, the first discharge part 121 discharging the coolant C, which has flowed in from the first opening H1 and has flowed through the internal space S downward, from the second opening H2 toward the target element, and the second discharge part 122 penetratingly provided in the body 100 so as to have the third opening H3 that opens into the internal space S above the first opening H1, the second discharge part 122 discharging the coolant C, which has been introduced from the first opening H1 and has flowed through the internal space S upward, from the third opening H3 toward the other element (here, the supply pipe 20).

Therefore, among the coolant C caused to flow into the internal space S from the first opening H1 by the first inflow part 111, a part of the coolant C that relatively contains a large amount of gas V flows through the internal space S upward and is discharged from the second discharge part 122 via the third opening H3, and the remainder of the coolant C that does not contain much gas V (or does not contain gas V) flows through the internal space S downward and is discharged from the first discharge part 121 via the second opening H2. Accordingly, by repeating the circulation of the coolant C using the branch joint 10, the gas V from the coolant C can be separated suitably. Thus, in the gas-liquid separation structure 1 according to the present embodiment, gas from the coolant C can be separated in the branch joint 10 for branching the coolant C (that is, without using a separate member such as a surge tank), and it is more efficient in terms of mass, cost, and space.

Further, in the gas-liquid separation structure 1 according to the present embodiment, the body 100 includes the constriction part 130 that narrows the internal space S at a position between the first opening H1 and the second opening H2 in the vertical direction D (as an example, the first position P1) so as to make the inner diameter of the internal space S narrower than the diameter D1 of the first opening H1. Therefore, among the coolant C that has flowed into the internal space S of the body 100 via the first opening H1, a part of the coolant C that relatively contains a large amount of gas V can be made difficult to flow downward (toward the second opening H2) by the constriction part 130, thereby making it possible to more effectively flow upward (toward the third opening H3) and be discharged from the second discharge part 122.

Further, the gas-liquid separation structure 1 according to the present embodiment further includes the supply pipe 20 as the other element that supplies the coolant C to the internal space S. Further, the branch joint 10 includes the second inflow part 112 penetratingly provided in the body 100 so as to have the fourth opening H4 that opens into the internal space S at the first position P1, the second inflow part 112 allowing the coolant C to flow into the internal space S from the fourth opening H4. Furthermore, the supply pipe 20 includes the first connection part 21 connected to the second discharge part 122 and the second connection part 22 connected to the second inflow part 112 below the first connection part 21, the supply pipe 20 supplying the coolant C to the internal space S by causing the coolant C discharged from the second discharge part 122 and introduced from the first connection part 21 to flow downward and leading the coolant C out from the second connection part 22 toward the second inflow part 112.

Therefore, by causing the coolant C discharged from the second discharge part 122 and introduced from the first connection part 21 to flow downward in the supply pipe 20 and leading the coolant C out from the second connection part 22 toward the second inflow part 112, gas-liquid separation of the coolant C can be reliably performed in the supply pipe 20.

Further, in the gas-liquid separation structure 1 according to the present embodiment, the inner diameter D20 of the supply pipe 20 is larger than the diameter D3 of the third opening H3 of the second discharge part 122. Therefore, when the coolant C is introduced from the second discharge part 122 into the supply pipe 20, the flow velocity of the coolant C becomes slower, thereby making it possible to more reliably perform gas-liquid separation of the coolant C in the supply pipe 20.

Further, the gas-liquid separation structure 1 according to the present embodiment includes the auxiliary tank 30 for storing the coolant C, and the connection pipe 40 that connects the supply pipe 20 and the auxiliary tank 30. The connection pipe 40 is connected to the supply pipe 20 at the upper end portion (one end portion 23) of the supply pipe 20 and is configured to discharge the gas V separated from the coolant C and stored in the one end portion 23 of the supply pipe 20 to the auxiliary tank 30. Therefore, the gas V separated from the coolant C in the supply pipe 20 can be discharged via the auxiliary tank 30.

Further, in the gas-liquid separation structure 1 according to the present embodiment, the connection pipe 40 is configured to supply the coolant C stored in the auxiliary tank 30 to the supply pipe 20 in response to a change in internal pressure of the supply pipe 20, by having the end portion (the other end portion 42) on the side opposite to the end portion (one end portion 41) connected to the supply pipe 20 immersed in the coolant C stored in the auxiliary tank 30. Thus, since the coolant C stored in the auxiliary tank 30 is supplied to the supply pipe 20 in response to a change in internal pressure of the supply pipe 20, the liquid amount of the coolant C in the system is suitably maintained.

Furthermore, in the gas-liquid separation structure 1 according to the present embodiment, the diameter Dp of the constriction part 130 is not less than ⅓ and not more than ½ of the diameter D1 of the first opening H1 of the first inflow part 111. Therefore, among the coolant C that has flowed into the internal space S of the body 100 from the first inflow part 111 via the first opening H1, a part of the coolant C that relatively contains a large amount of gas can be more effectively caused to flow upward (toward the third opening H3) and be discharged from the second discharge part 122.

The above embodiment describes one aspect of the present disclosure. Therefore, the present disclosure is not limited to the above embodiment and may be arbitrarily modified.

For example, the branch joint 10 may have a lid part 140 that is detachably provided on the body 100 so as to be provided at an upper part of the body 100 and to close an opening that opens the internal space S to the outside. In this case, by removing the lid part 140, the internal space S of the body 100 can be accessed.

Further, the one end portion 23, which is the upper end portion of the supply pipe 20, may be open upward, and a cap 50 may be detachably attached so as to close the opening. In this case, by removing the cap 50, the coolant C can be supplied into the supply pipe 20.

Further, a window portion may be formed on at least a part of an outer surface of the auxiliary tank 30, so that a liquid level of the coolant C stored in the auxiliary tank 30 can be checked from outside the auxiliary tank 30. In this case, by viewing the auxiliary tank 30 from the outside, whether replenishment of the coolant C is necessary can be easily checked.

Furthermore, by positioning the first connection part 21 of the supply pipe 20 sufficiently above the second discharge part 122 in the branch joint 10, the gas V in the supply pipe 20 can be prevented from returning to the second discharge part 122.

What is claimed is:

1. A gas-liquid separation structure that is mounted on a vehicle and is configured to separate gas from a coolant while circulating the coolant for cooling a target element of the vehicle, the structure comprising,
a branch joint configured to receive inflow of the coolant returning from the target element and to discharge the inflowed coolant in a branched manner to the target element and other element,
wherein the branch joint comprises:
a body having an internal space elongated in a vertical direction;
a first inflow part penetratingly provided in the body so as to have a first opening that opens into the internal space, the first inflow part allowing the coolant returning from the target element to flow into the internal space from the first opening;
a first discharge part penetratingly provided in the body so as to have a second opening that opens into the internal space below a first position that is below the first opening, the first discharge part discharging the coolant, which has flowed in from the first opening and has flowed through the internal space downward, from the second opening toward the target element; and
a second discharge part penetratingly provided in the body so as to have a third opening that opens into the internal space above the first opening, the second discharge part discharging the coolant, which has been introduced from the first opening and has flowed through the internal space upward, from the third opening toward the other element.

2. The gas-liquid separation structure according to claim 1, wherein the body comprises a constriction part that narrows the internal space at the first position so as to make an inner diameter of the internal space narrower than a diameter of the first opening.

3. The gas-liquid separation structure according to claim 2, wherein a diameter of the constriction part is not less than ⅓ and not more than ½ of a diameter of the first opening of the first inflow part.

4. The gas-liquid separation structure according to claim 1, further comprising a supply pipe as the other element configured to supply the coolant to the internal space,
wherein the branch joint comprises a second inflow part penetratingly provided in the body so as to have a fourth opening that opens into the internal space below the first position, the second inflow part allowing the coolant to flow into the internal space from the fourth opening, and
wherein the supply pipe includes a first connection part connected to the second discharge part and a second connection part connected to the second inflow part below the first connection part, the supply pipe supplying the coolant to the internal space by causing the coolant discharged from the second discharge part and introduced from the first connection part to flow downward and leading the coolant out from the second connection part toward the second inflow part.

5. The gas-liquid separation structure according to claim 4, wherein an inner diameter of the supply pipe is larger than a diameter of the third opening of the second discharge part.

6. The gas-liquid separation structure according to claim 4, further comprising:
an auxiliary tank configured to store the coolant; and
a connection pipe configured to connect the supply pipe and the auxiliary tank,
wherein the connection pipe is connected to the supply pipe at an upper end portion of the supply pipe and is configured to discharge the gas separated from the coolant and stored in the upper end portion of the supply pipe to the auxiliary tank.

7. The gas-liquid separation structure according to claim 6, wherein the connection pipe is configured to supply the coolant stored in the auxiliary tank to the supply pipe in response to a change in internal pressure of the supply pipe, by having an end portion on a side opposite to an end portion connected to the supply pipe immersed in the coolant stored in the auxiliary tank.
